(19) United States
(12) Patent Application Publication
(10) Pub. No.: US 2005/0026110 A1
(43) Pub. Date: Feb. 3, 2005

(54) Seal for a medical handpiece

(75) Inventors: Norbert Schatz, Burmoos (AT); Gerhard Hochradl, St. Pantaleon (AT)

Correspondence Address: KLARQUIST SPARKMAN, LLP, 121 SW SALMON STREET, SUITE 1600, PORTLAND, OR, 97204, US

(73) Assignee: W & H Dentalwerk Burmoos GmbH

(21) Appl. No.: 10/894,794

(22) Filed: Jul. 19, 2004

(30) Foreign Application Priority Data
Jul. 31, 2003 (AT) A 1214/2003

(51) Int. Cl. A61C 1/05

(52) U.S. Cl. 433/115

(57) ABSTRACT

The present invention relates to a seal in the tool side of a straight or contra angle handpiece head for sealing the interior of straight or contra angle handpieces. The seal is characterised by a spring, which prestresses a gasket of compressible elastic material against a fixed component and a rotating disk located in the immediate vicinity of the seal. Moreover, the present invention relates to a straight or contra angle handpiece with such a seal.

### CROSS REFERENCE TO RELATED APPLICATION

The present application claims priority from pending Austrian Patent Application No. A 1214/2003, filed Jul. 31, 2003, which is incorporated herein by reference.

### BACKGROUND OF THE INVENTION

1. Field

The present invention relates to a seal in the tool side of a straight or contra angle handpiece head for sealing the interior of straight or contra angle handpiece.

2. Description of Prior Art

The necessity for sealing exists due to the danger of transferring pathogens between patients, which pathogens are transported into the straight or contra angle handpiece via bodily fluids such as blood or saliva, and for protection of the components within the straight or contra angle handpiece, such as the clamping device, the bearings and the drive shafts, against soiling and damage from tissue during treatment, such as pieces of bone, or from substances employed during treatment, such as pastes, for example. Retainment of lubricating agents from bearings within the straight or contra angle handpiece must also be guaranteed by the seal, particularly during treatment.

The fundamental problem in sealing the straight or contra angle handpieces against the environment is that tools, which are actuated by a drive, for example rotating drills, brushes, Prophy Cups, protrude from the head. In order to ensure safe operation of the straight or contra angle handpieces with low wear, low noise, the rotating tools and associated components, such as, for example, the drive shaft and the spindle, operate with a clearance to the non-rotating, fixed components, such as the outer sleeve and the bearings. The particles and soiling described above can enter into the straight and contra angle handpieces through gaps between the fixed and moving parts.

To keep soiling entry to a minimum, a variety of devices are known that are employed in a number of application areas, such as implantology, prophylaxis or the mechanical removal of tissue; very often, labyrinth seals are used to seal the gaps between the fixed and moving parts; see EP 997 110 A2, for example. Disadvantageous here is once again the existence of gaps between the components of the labyrinth seal, through which small particles, fluids, and substances dissolved and dispersed within them, can penetrate the interior of the straight or contra angle handpiece.

By means of rotating disks (splash guards), an attempt has been made to keep particles and soiling out of the head area of the straight or contra angle handpiece, or to hurl them away. These rotating disks are therefore attached to rotating components, for example to the drive shaft or to the tool itself; see U.S. Pat. No. 6,350,124 B1, FIGS. 7A-7C. Here, too, however, there is clearance between the rotating disk and the fixed components, through which soiling can penetrate the interior of the straight or contra angle handpiece.

In prophylaxis contra angle handpieces used for polishing the tooth surface, a particularly good seal is necessary, because the polishing treatment pastes are distributed especially close to the contra angle handpiece head by the tool (a so-called Prophy Cup). In patent U.S. Pat. No. 3,436,830, a sealing ring rotating with the tool is proposed, the cylindrical extension of which protrudes into the tool side of the contra angle handpiece head. The sealing ring is pressed against the contra angle handpiece head through a Prophy Cup apron.

In the patent U.S. Pat. No. 5,642,995, a cap with a cutting tool, which cuts into a cylindrical extension of the Prophy Cup when the cup is screwed into the tool coupling, is fitted to the head of the contra angle handpiece.

Disadvantageous in both documents is that specially formed Prophy Cups with extensions are required in each case. In particular, the seal described in the '830 patent requires extremely high manufacturing precision (low tolerance) for the apron in order to exercise correct sealing force on the sealing ring.

The present invention therefore has the aim of creating an improved seal. In particular, the seal can be utilized universally in various straight or contra angle handpieces, for example for implantology, prophylaxis or for mechanical removal of tissue, achieving a reduction in production costs. For prophylaxis contra angle handpieces, the seal must be designed such that special Prophy Cups are not necessary, giving the user greater choice in the selection of Cups.

### SUMMARY OF THE INVENTION

In one embodiment of the present invention, a seal is provided that is adapted for substantially universal use with a variety of straight or contra angle handpieces.

In order to achieve the greatest possible sealing effect in an embodiment of the present invention, a gasket, preferably of the grommet type, is prestressed against a fixed component by a spring. The gasket consists of an elastically compressible material, preferably rubber. This allows the dimensions of the gasket to be selected such that it can be slightly compressed by the surrounding components and so that when installed it fits very tightly to the fixed components in particular, thereby achieving a very good sealing effect. The spring holding the gasket against the fixed components also increases the sealing effect of the gasket, in particular in the direction of the tool side of the straight or contra angle handpiece head.

In yet another embodiment of the invention, a splash guard is located in the immediate vicinity of the gasket, preferably in direct contact with the gasket. Because of the direct contact with the gasket and the resulting extremely small spacing to the head of the straight or contra angle handpiece, a rotating disk already prevents entry of a large proportion of soiling elements. Particles or fluid droplets penetrating as far as the gap between the rotating disk and the head of the straight or contra angle handpiece are hindered in entering the interior of the straight or contra angle handpiece by the gasket, which lies tightly in contact with the surrounding components. In addition, the spring automatically compensates for any wear of the gasket by increasing the travel of the spring and in this way guarantees a uniform quality sealing effect.

In a preferred embodiment, in order to minimize gasket wear in the area of contact with the rotating disk and thus ensure effective sealing after prolonged seal use, and to achieve optimum force transmission from the spring to the gasket, washers, preferably of metal, are situated between the gasket and the rotating disk and/or between the gasket and the spring.

### BRIEF DESCRIPTION OF THE DRAWINGS

The invention is described below based on preferred embodiments and with reference to the drawings provided:

FIG. 1 shows the head of a prophylaxis contra angle handpiece with a seal according to an embodiment of the invention.

FIG. 2 shows the seal of FIG. 1 enlarged in sectional representation.

FIG. 3 shows the head of a contra angle handpiece for mechanical removal of tissue with a seal according to another embodiment of the invention.

In all figures, the same components are labelled with the same numbers.

### DETAILED DESCRIPTION OF THE PREFERRED EMBODIMENTS

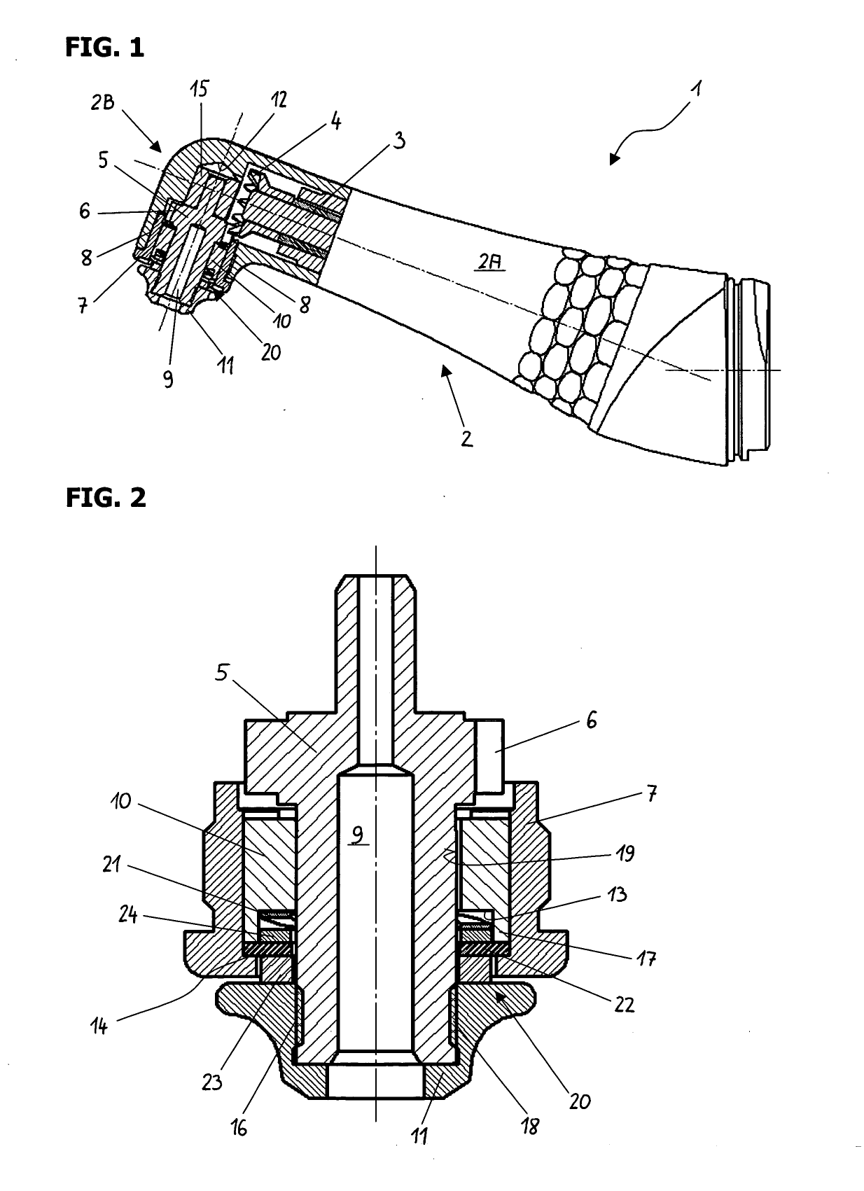

The head 1 of a prophylaxis contra angle handpiece represented in FIG. 1 consists of an outer sleeve 2 with a handle sleeve section 2A and an adjacent contra angled head sleeve section 2B. A drive shaft 3 is located in the handle sleeve section 2A and is set rotating by a motor (not represented), for example an air motor. In a bore 12 in the head sleeve section 2B, a driven shaft 5 is located in two bushings, or bearings, 10, 15. The distal end of the driven shaft 5 is developed as a rotatable tool carrier 9, into which a prophylaxis tool can be inserted by means of a screw thread. At the distal end of the tool carrier 9 is a rotating disk 11, preferably removable from the tool carrier 9, for example by means of a screw or push connector. The rotary action of drive shaft 3 is transmitted to the driven shaft 5, the tool and the rotating disk 11 by means of gear wheels 4 and 6.

Parts of a seal 20, according to an embodiment of the invention, are located in a recess 13 in the bushing, or bearing, 10 (FIG. 2). The driven shaft 5, the two bearings 10 and 15 and the seal 20 are fixed in a bore 12 by means of a ring nut 7, which is screwed by a thread 8 into the head sleeve section 2B. It can be seen in FIG. 2 that the ring nut 7 has a radially inwardly directed interior shoulder 14 on the tool carrier side, which accepts a gasket 22, which is part of the seal 20. The gasket 22, which may be formed of an elastic material, comprises a ring that encircles tool carrier 9. The gasket is clamped against the shoulder 14 by means of a dog 17 on the lower bushing, or bearing, 10, which is a press fit in ring nut 7. A spring 21 and a washer 24 are located in the recess 13 in the lower bushing 10. The spring 21, preferably a leaf spring, exerts a force on the gasket 22 in the direction of the distal end of the tool carrier 9 and presses the gasket 22 against a further washer 23. The rotating disk 11 is affixed to the top drive 5 via threads 16, 18 on the outside of the top drive 5 and the inside of the rotating disk 11 and, simultaneously, by screwing on the rotating disk 11, the washer 23 is pressed against the gasket 22.

Because of the compressible elastic material properties of the gasket 22 and the distal and proximal forces exercised, the gasket 22 engages all fixed, non-rotating components (ring nut 7, bushing 10, washers 23 and 24), without a gap. The washer 23 does not rotate, because the frictional resistance between the elastic gasket 22 and the metal washer 23 is greater than between the metal rotating disk 11 and the metal washer 23. Both washers 23, 24 are preferably manufactured from metal, in particular washer 23 is preferably manufactured from hard alloy. None of the components of seal 20 (spring 21, gasket 22 and washers 23, 24) contact the outer surface 19 of the rotating driven shaft 5, circumventing wear or noise generation. The only contact between a rotating and a fixed component is between the washer 23 and the rotating disk 11. The contact surface between these two components is, however, very small, so that noise generation is also small. By the sound choice of materials, in particular the hard alloy washer 23, wear can be kept extremely low, ensuring no gap occurs through which soiling elements can penetrate into the interior of the contra angle head 1, even after prolonged use of the seal 20. The seal 20 thus represents, in particular in combination with the rotating disk 11, a simple, durable and economical seal.

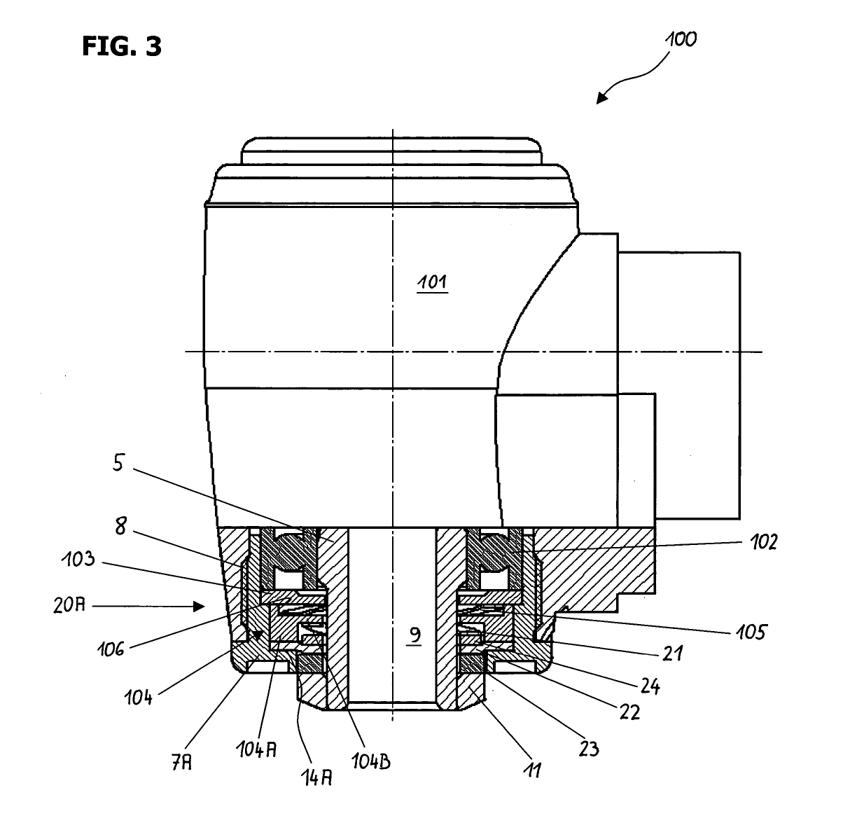

The configuration of another embodiment of seal 20A represented in FIG. 3 in the head 100 of a contra angle handpiece for mechanical removal of tissue corresponds somewhat to those shown in FIGS. 1 and 2. However, a substantially higher speed is required for such contra angle handpieces, so that the driven shaft 5 in the head 100 is supported in ball bearings (due to the only partially cut away outer sleeve 101, only one bearing 102 is visible). In this embodiment, the bushing 10 serving as a seat for at least part of the seal 20 in the embodiment of FIG. 2 is missing. Instead, a fixation disk 104 is located at the proximal end of seal 20A, the shoulder 104A of which clamps the gasket 22 against the shoulder 14A of the ring nut 7A. The extension 104B serves as a seat for spring 21. A spring 105, which prestresses the ball bearing 102 by means of a distance piece 103, is located in a recess 106 in the fixation disk 104. It can be recognized from this embodiment that, by simple modification, the seal of the invention can be adapted for universal use in straight and contra angle handpieces in a variety of applications.

The invention is not restricted to the represented applications and embodiments, but encompasses all possible embodiments that do not alter the basic design principle of the invention and analogous functions. In particular, the type and shape of the gasket and the washers, as well as the location and type of bearing of the invented seal, are variable and shall be adapted to the variety of spatial relationships in the different straight and contra angle handpieces.

1. A seal for sealing a tool end of a medical straight or contra angle handpiece, said seal comprising
a fixed component,
a gasket of compressible elastic material,
a spring which urges the gasket against the fixed component, and
a rotating disk located in the immediate vicinity of the seal.

2. A seal according to claim 1, which further comprises a substantially rigid washer interposed between the gasket and the rotating disk.

3. A seal according to claim 2, wherein said washer is composed of metal.

4. A seal according to claim 2, wherein said rotating disk is positioned to engage said washer.

5. A seal according to claim 1, wherein said rotating disk is positioned to contact the gasket.

6. A seal according to claim 1, which further comprises a substantially rigid washer interposed between the spring and gasket.

7. A seal according to claim 1 wherein the handpiece has a rotatable tool carrier and the rotating disk is detachably connected to the tool carrier.

8. A seal according to claim 7, wherein said gasket comprises a ring which encircles a portion of the rotatable tool carrier.

9. A seal according to claim 8, wherein said fixed component surrounds the tool carrier and the gasket and has a radially inwardly directed shoulder against which a portion of said gasket rests.

10. A seal according to claim 1, wherein said spring comprises a leaf spring.

11. A seal for sealing a tool end of a medical straight or contra angle handpiece having a rotatable tool carrier, said seal comprising
a fixed component surrounding a portion of said tool carrier,
a gasket of compressible elastic material,
a spring which urges the gasket against the fixed component,
a rotating disk detachably connected to the tool carrier and located in the vicinity of the seal,
a substantially rigid washer interposed between the gasket and rotating disk, and
a substantially rigid washer interposed between the spring and the gasket.

12. A seal according to claim 11, wherein said gasket comprises a ring which encircles a portion of the rotatable tool carrier.

13. A seal according to claim 12, wherein said fixed component surrounds a portion of the gasket and has a radially inwardly directed shoulder against which a portion of said gasket rests.

14. A seal according to claim 11, wherein said spring comprises a leaf spring.

15. A medical straight or contra angle handpiece with an outer sleeve containing a shaft to drive a rotatable tool carrier adapted to receive a treatment tool, said handpiece having a seal assembly comprising
a fixed component,
a gasket of compressible elastic material,
a spring which urges the gasket against the fixed component, and
a rotating disk located in the immediate vicinity of the seal.

16. A handpiece according to claim 15, which further comprises a substantially rigid washer interposed between the gasket and the rotating disk.

17. A handpiece according to claim 16, wherein said washer is composed of metal.

18. A handpiece according to claim 16, wherein said rotating disk is positioned to engage said washer.

19. A handpiece according to claim 15, wherein said rotating disk is positioned to contact the gasket.

20. A handpiece according to claim 15, which further comprises a substantially rigid washer interposed between the spring and gasket.

21. A handpiece according to claim 15, wherein the rotating disk is detachably connected to the tool carrier.

22. A handpiece according to claim 15, which further comprises a bushing which guides said tool carrier and has a recess in which said spring is located.
